(19) United States
(12) Patent Application Publication
(10) Pub. No.: US 2024/0094655 A1
(43) Pub. Date: Mar. 21, 2024

(54) ELECTROSTATIC CHARGE IMAGE DEVELOPING TONER, ELECTROSTATIC CHARGE IMAGE DEVELOPER, TONER CARTRIDGE, PROCESS CARTRIDGE, AND IMAGE FORMING APPARATUS

(71) Applicant: FUJIFILM Business Innovation Corp., Tokyo (JP)

(72) Inventors: Yosuke TSURUMI, Kanagawa (JP); Moegi IGUCHI, Kanagawa (JP); Yukiko KAMIJO, Kanagawa (JP)

(73) Assignee: FUJIFILM Business Innovation Corp., Tokyo (JP)

(21) Appl. No.: 18/189,231

(22) Filed: Mar. 24, 2023

(30) Foreign Application Priority Data
Sep. 1, 2022 (JP) 2022-139504

(51) Int. Cl. G03G 9/097; G03G 15/08

(52) U.S. Cl. CPC G03G 9/09725; G03G 9/09733; G03G 15/0865

(57) ABSTRACT

An electrostatic charge image developing toner contains alkylsilane-treated silica particles, a branched aliphatic hydrocarbon having 7 or more and 18 or less carbon atoms, and toner particles.

### CROSS-REFERENCE TO RELATED APPLICATIONS

This application is based on and claims priority under 35 USC 119 from Japanese Patent Application No. 2022-139504 filed Sep. 1, 2022.

### BACKGROUND

### (i) Technical Field

The present invention relates to an electrostatic charge image developing toner, an electrostatic charge image developer, a toner cartridge, a process cartridge, and an image forming apparatus.

### (ii) Related Art

JP2013-117564A suggests “a two-component developer composed of a toner and a carrier, in which the toner is composed of a toner base particles that contain at least a binder resin and a colorant and a silica compound (A) and a silica compound (B) that are added to a surface of the toner base particles, the silica compound (A) has undergone a surface treatment with at least any one of n-butyltrimethoxysilane or t-butyltrimethoxysilane, and the silica compound (B) has under undergone a surface treatment with at least any one of hexamethyldisilazane or octyltrimethoxysilane.”

### SUMMARY

Aspects of non-limiting embodiments of the present disclosure relate to an electrostatic charge image developing toner that contains alkylsilane-treated silica particles and toner particles that is further inhibited from adhering to a non-image portion in a case where the toner is used to continuously form images in a low-temperature and low-humidity environment (for example, 10° C. and 15% RH), then stored in a high-temperature and high-humidity environment (for example, 28° C. and 88% RH), and reused to form images, compared to an electrostatic charge image developing toner containing a branched aliphatic hydrocarbon having less than 7 carbon atoms or a branched aliphatic hydrocarbon having more than 18 carbon atoms.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for achieving the above object include the following means.

According to an aspect of the present disclosure, there is provided an electrostatic charge image developing toner containing:
alkylsilane-treated silica particles;
a branched aliphatic hydrocarbon having 7 or more and 18 or less carbon atoms; and toner particles.

### BRIEF DESCRIPTION OF THE DRAWINGS

Exemplary embodiment(s) of the present invention will be described in detail based on the following figures, wherein:

FIG. 1 is a view schematically showing the configuration of an image forming apparatus according to the present exemplary embodiment; and

FIG. 2 is a view schematically showing the configuration of a process cartridge according to the present exemplary embodiment.

### DETAILED DESCRIPTION

The exemplary embodiments as an example of the present invention will be described below. The following descriptions and examples merely illustrate the exemplary embodiments, and do not limit the scope of the invention.

Regarding the ranges of numerical values described in stages in the present specification, the upper limit or lower limit of a range of numerical values may be replaced with the upper limit or lower limit of another range of numerical values described in stages. Furthermore, in the present specification, the upper limit or lower limit of a range of numerical values may be replaced with values described in examples.

Each component may include a plurality of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

Electrostatic Charge Image Developing Toner

The electrostatic charge image developing toner according to the present exemplary embodiment (hereinafter, also called “toner”) contains alkylsilane-treated silica particles, a branched aliphatic hydrocarbon having 7 or more and 18 or less carbon atoms (hereinafter, also called “specific branched aliphatic hydrocarbon”), and toner particles.

Due to the above configuration, in a case where the toner according to the present exemplary embodiment is used to continuously form images in a low-temperature and low-humidity environment, then stored in a high-temperature and high-humidity environment, and reused to form images, the toner is inhibited from adhering to a non-image portion. The reason is presumed as follows.

From the viewpoint of fluidity of a toner and charge control for a toner, sometimes hydrophobic silica particles are used as an external additive. From the viewpoint of ease of a hydrophobic treatment, for example, it is preferable to use alkylsilane-treated silica particles as the silica particles. However, due to the steric hindrance of the alkyl group in the alkylsilane used for the alkylsilane treatment, sometimes it is difficult to make the surface of the silica particles substantially uniformly hydrophobic, and the silica particles have a non-hydrophobic portion in some cases. On this occasion, in a case where the toner having silica particles including the non-hydrophobic portion that are added to the exterior of the toner is used to continuously form images in a low-temperature and low-humidity environment, then stored in a high-temperature and high-humidity environment, and reused to form images, sometimes the toner easily adheres to a non-image portion.

As the reason, it is considered that in a case where the toner is used to continuously form images in a low-temperature and low-humidity environment and then stored in a high-temperature and high-humidity environment, charge may leak from the non-hydrophobic portion of the silica particles due to the influence of humidity change accompanied by temperature change, and the charge of the toner may be reduced. The leakage of charge is further promoted at a high temperature accompanied by a temperature change after continuous image formation in a low-temperature and low-humidity environment.

The toner according to the present exemplary embodiment contains alkylsilane-treated silica particles and a branched aliphatic hydrocarbon having 7 or more and 18 or less carbon atoms. The side chain of the specific branched aliphatic hydrocarbon and the alkyl group derived from the alkylsilane are easily entangled with each other. Therefore, the specific branched aliphatic hydrocarbon is likely to present on the surface of the alkylsilane-treated silica particles. In addition, the main chain of the specific branched aliphatic hydrocarbon is likely to present in the non-hydrophobic portion within the surface of the alkylsilane-treated silica particles. Therefore, in a case where the toner is used to continuously form images in a low-temperature and low-humidity environment and then stored in a high-temperature and high-humidity environment, the leakage of charge from the non-hydrophobic portion of the alkylsilane-treated silica particles is suppressed, and the reduction of charge of the toner is suppressed.

The shape of the branched portion of the specific branched aliphatic hydrocarbon is unlikely to change depending on the temperature. Therefore, even in a case where the specific branched aliphatic hydrocarbon is still easily entangled with the alkyl group derived from the alkylsilane, and the molecular motion of the specific branched aliphatic hydrocarbon is stimulated due to temperature rise, the specific branched aliphatic hydrocarbon is unlikely to be isolated from the surface of the alkylsilane-treated silica particles. In a case where the toner is used to continuously form images in a low-temperature and low-humidity environment and then stored in a high-temperature and high-humidity environment, the leakage of charge from the non-hydrophobic portion of the alkylsilane-treated silica particles is suppressed, and the reduction of charge of the toner is suppressed.

Furthermore, it is considered that in a case where the branched aliphatic hydrocarbon has 7 or more carbon atoms, the main chain of the specific branched aliphatic hydrocarbon is likely to be selectively present in the non-hydrophobic portion where few alkyl groups exist within the surface of the alkylsilane-treated silica particles, and, for example, the surface of the silica particles treated with an alkylsilane thus may be made hydrophobic to a suitable degree. It is also considered that in a case where the branched aliphatic hydrocarbon has 18 or less carbon atoms, the branched aliphatic hydrocarbon is unlikely to be isolated from the surface of the alkylsilane-treated silica particles. As the reason, it is considered that in a case where the specific branched aliphatic hydrocarbon has more than 18 carbon atoms, due to the steric hindrance thereof, the side chain of the specific branched aliphatic hydrocarbon and the alkyl group derived from the alkylsilane may be easily entangled with each other, and the specific branched aliphatic hydrocarbon may be easily isolated from the alkylsilane-treated silica particles.

Therefore, the non-hydrophobic portion of the alkylsilane-treated silica particles is made hydrophobic by the specific branched aliphatic hydrocarbon. As a result, the leakage of charge from the non-hydrophobic portion is suppressed, and the reduction of charge of the toner is also suppressed. In addition, because the specific branched aliphatic hydrocarbon is unlikely to be isolated from the silica particles treated with an alkylsilane as described above, the effect of making the non-hydrophobic portion of the alkylsilane-treated silica particles hydrophobic is likely to last.

Presumably, for the reasons described above, in a case where the toner according to the present exemplary embodiment is used to continuously form images in a low-temperature and low-humidity environment, then stored in a high-temperature and high-humidity environment, and reused to form images, the toner may be inhibited from adhering to a non-image portion.

Alkylsilane-Treated Silica Particles

The toner according to the present exemplary embodiment contains alkylsilane-treated silica particles.

The alkylsilane-treated silica particles are silica particles having undergone a surface treatment with an alkylsilane.

Hereinafter, the silica particles to be subjected to a surface treatment with an alkylsilane may be silica, that is, particles containing SiO₂ as a main component. In the present specification, “main component” refers to a component that occupies equal to or more than 50% of a total mass of a mixture of a plurality of kinds of components.

The alkylsilane is a silicon compound having an alkyl group that is directly bonded to a silicon atom.

The number of carbon atoms of the alkyl group contained in the alkylsilane is, for example, preferably 1 or more and 3 or less, more preferably 1 or more and 2 or less, and even more preferably 1.

The alkylsilane is, for example, preferably a silicon compound having an alkyl group and an alkoxy group, and more preferably a compound consisting of an alkyl group, an alkoxy group, and a silicon atom.

A preferable numerical range of the number of carbon atoms of the alkoxy group is, for example, the same as the numerical range of the number of carbon atoms of the alkyl group of the alkylsilane.

The number of alkyl groups contained in the alkylsilane is, for example, preferably 1 or more and 3 or less, more preferably 1 or 3, and even more preferably 3, per silicon atom.

The number of alkoxy groups contained in the alkylsilane is, for example, preferably 1 or more and 3 or less, more preferably 1 or 3, and even more preferably 1, per silicon atom.

The alkylsilane is, for example, preferably at least one kind of compound selected from the group consisting of alkylsilanes represented by Formula (1), Formula (2), and Formula (3).

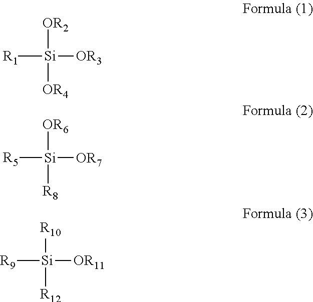

In Formula (1) to Formula (3), R₁ to R₁₂ each independently represent an alkyl group having 1 or more and 3 or less carbon atoms.

A preferable numerical range of the number of carbon atoms of the alkyl group represented by R₁ to R₁₂ is, for example, the same as the numerical range of the number of carbon atoms of the alkyl group of the alkylsilane.

In Formula (1), for example, R₁ to R₄ preferably each represent at least one kind of group selected from the group consisting of a methyl group, an ethyl group, and a propyl group, and more preferably all represent a methyl group.

In Formula (2), for example, R₅ to R₈ preferably each represent at least one kind of group selected from the group consisting of a methyl group, an ethyl group, and a propyl group, and more preferably all represent a methyl group.

In Formula (3), for example, R₉ to R₁₂ preferably each represent at least one kind of group selected from the group consisting of a methyl group, an ethyl group, and a propyl group, and more preferably all represent a methyl group.

In a case where at least one compound selected from the group consisting of alkylsilanes represented by Formula (1) to Formula (3) is used as the alkylsilane, in a case where the toner is used to continuously form images in a low-temperature and low-humidity environment, then stored in a high-temperature and high-humidity environment, and reused to form images, the toner is further suppressed from adhering to a non-image portion.

Presumably, this is because the alkylsilane represented by Formula (1) to Formula (3) is easily entangled with the side chain of the specific branched aliphatic hydrocarbon.

From the viewpoint of further suppressing adhesion of the toner to a non-image portion, for example, the alkylsilane is preferably an alkylsilane represented by Formula (1) or Formula (3).

It is preferable that all the alkyl groups of the alkylsilanes represented by Formula (1) to Formula (3) be, for example, methyl groups.

In a case where all the alkyl groups of the alkylsilanes represented by Formula (1) to Formula (3) are methyl groups, the hydrophobicity is high. Therefore, the hydrophobicity of the alkylsilane-treated silica particles is further increased. In addition, because the steric hindrance is small, the surface of the silica particles is likely to be uniformly treated, and the alkylsilane is more easily entangled with the side chain of the specific branched aliphatic hydrocarbon. It is considered that accordingly, the leakage of charge resulting from the influence of the temperature change and high humidity may be further suppressed.

The average primary particle size of the alkylsilane-treated silica particles is, for example, preferably 20 nm or more and 200 nm or less, more preferably 40 nm or more and 150 nm or less, and even more preferably 70 nm or more and 140 nm or less.

From the viewpoint of charge retention at a high temperature and a high humidity, the average primary particle size of the alkylsilane-treated silica particles is, for example, preferably 70 nm or more and 200 nm or less, more preferably 70 nm or more and 180 nm or less, and even more preferably 80 nm or more and 100 nm or less.

The leakage of charge at a high temperature and a high humidity occurs, for example, between the toner surface and a low resistance portion of a carrier coming into contact with the toner surface, specifically, a core material exposure portion or conductive particles of a coating resin. At this time, in a case where the particle size of the alkylsilane-treated silica particles is in the above range, the contact points between the toner surface and the carrier are reduced, which suppresses the leakage of charge.

The average primary particle size of the alkylsilane-treated silica particles is measured by the following method.

Primary particles of the alkylsilane-treated silica particles are observed and imaged with a scanning electron microscope (SEM) device (S-4100, manufactured by Hitachi, Ltd.), the image is input in an image analyzer (LUZEXIII, manufactured by NIRECO.) to measure the area of each of the primary particles by image analysis, and an equivalent circular diameter is calculated from the areas. This equivalent circular diameter is calculated for 100 alkylsilane-treated silica particles. Then, in a volume-based cumulative frequency distribution of the obtained equivalent circular diameter, a diameter at which the percentage of the particles is 50% (D50) is adopted as the average primary particle size of the alkylsilane-treated silica particles (average equivalent circular diameter D50). The magnification of the electron microscope is adjusted such that about 10 or more and 50 or less alkylsilane-treated silica particles are projected in one field of view. The equivalent circular diameter of the primary particles is determined by combining observation results obtained in a plurality of fields of view.

The content of the alkylsilane-treated silica particles with respect to the mass of the toner particles is, for example, preferably 0.01% by mass or more and 10% by mass or less, more preferably 0.05% by mass or more and 5% by mass or less, and even more preferably 0.1% by mass or more and 3% by mass or less.

Manufacturing Method of Alkylsilane-Treated Silica Particles

The alkylsilane-treated silica particles are manufactured through manufacturing of silica base particles and alkylsilane treatment.

Manufacturing of Silica Base Particles

It is preferable that the silica base particles be manufactured, for example, by a wet method.

“Wet method” is different from a gas phase method and is a manufacturing method performed by neutralizing sodium silicate with a mineral acid or hydrolyzing an alkoxysilane.

It is preferable that the silica base particles be manufactured, for example, by a sol-gel method among wet methods.

Hereinafter, as a manufacturing method of the silica base particles, a sol-gel method will be described for example.

The manufacturing method of the silica base particles is not limited to the sol -gel method.

The particle size of the silica base particles can be freely controlled by the hydrolysis of the sol-gel method, the weight ratio of alkoxysilane, ammonia, alcohol, and water in a polycondensation step, the reaction temperature, the stirring rate, and the supply rate.

Hereinafter, the manufacturing method of the silica base particles by a sol-gel method will be specifically described.

That is, while being heated, tetramethoxysilane is added dropwise and stirred in the presence of water and alcohol, by using aqueous ammonia as a catalyst. Then, the solvent is removed from the silica sol suspension obtained by the reaction, followed by drying, thereby obtaining target silica base particles.

Alkylsilane Treatment

Examples of the alkylsilane treatment method include a method of using supercritical carbon dioxide and dissolving an alkylsilane in the supercritical carbon dioxide such that the alkylsilane adheres to the surface of silica base particles; a method of applying a solution, which contains an alkylsilane and a solvent dissolving the alkylsilane, to the surface of the silica base particles in the air (for example, by spraying or coating) such that the alkylsilane adheres to the surface of the silica base particles; and a method of adding a solution, which contains an alkylsilane and a solvent dissolving the alkylsilane, to a silica base particle dispersion in the air, keeping the obtained mixed solution as it is, and then drying the mixed solution of the silica base particle dispersion and the solution.

Specific Branched Aliphatic Hydrocarbon

The toner according to the present exemplary embodiment contains a specific branched aliphatic hydrocarbon.

The specific branched aliphatic hydrocarbon is a branched aliphatic hydrocarbon having 7 or more and 18 or less carbon atoms.

The branched aliphatic hydrocarbon mentioned herein is an aliphatic hydrocarbon having a main chain and a side chain. The main chain means a chain consisting of the largest number of consecutive carbon atoms constituting the branched aliphatic hydrocarbon, and the side chain means a hydrocarbon group bonded to the main chain.

The number of carbon atoms of the specific branched aliphatic hydrocarbon is, for example, preferably 7 or more and 14 or less, more preferably 7 or more and 13 or less, and even more preferably 8 or more and 12 or less.

It is considered that in a case where the specific branched aliphatic hydrocarbon has 7 or more carbon atoms, the main chain of the specific branched aliphatic hydrocarbon is likely to be present in the non-hydrophobic portion where few alkyl groups exist within the surface of the alkylsilane-treated silica particles, and, for example, the surface of the silica particles treated with an alkylsilane thus may be made hydrophobic to a suitable degree. It is also considered that in a case where the branched aliphatic hydrocarbon has 18 or less carbon atoms, the branched aliphatic hydrocarbon is unlikely to be isolated from the alkylsilane-treated silica particles.

The specific branched aliphatic hydrocarbon preferably has, for example, a quaternary carbon.

Using the specific branched aliphatic hydrocarbon having a quaternary carbon further suppresses the adhesion of the toner to a non-image portion, in a case where the toner is used to continuously form images in a low-temperature and low-humidity environment, then stored in a high-temperature and high-humidity environment, and reused to form images.

As the reason, presumably, in a case where the specific branched aliphatic hydrocarbon has a quaternary carbon, the number of side chains may increase, and the side chains may be more easily entangled with the alkyl group derived from the alkylsilane.

For example, it is preferable that the specific branched aliphatic hydrocarbon have a quaternary carbon, and the quaternary carbon be contained in a group represented by Formula (4).

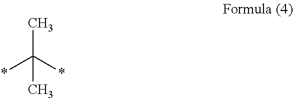 [SMILES: *C(*)(C)C]

In Formula (4), * represents a bonding site.

In Formula (4), it is preferable that each * be bonded to, for example, a carbon atom contained in the main chain. That is, for example, the specific branched aliphatic hydrocarbon preferably has a structure in which at least one of the carbon atoms contained in the main chain is a quaternary carbon, and 2 methyl groups are bonded to the quaternary carbon.

Using the specific branched aliphatic hydrocarbon having a quaternary carbon contained in a group represented by Formula (4) further suppresses the adhesion of the toner in a non-image portion, in a case where the toner is used to continuously form images in a low-temperature and low-humidity environment, then stored in a high-temperature and high-humidity environment, and reused to form images.

In a case where the specific branched aliphatic hydrocarbon has the group represented by Formula (4), the specific branched aliphatic hydrocarbon has a methyl group as a side chain. Presumably, in a case where the methyl group forms the side chain, the side chain is more easily entangled with the alkyl group derived from the alkylsilane, which may further suppress the adhesion of the toner to a non-image portion.

From the viewpoint of further suppressing the adhesion of the toner to a non-image portion, the specific branched aliphatic hydrocarbon is, for example, preferably at least one kind of compound selected from the group consisting of 2,2,3-trimethyldecane, 2,3-dimethyldecane, 2,2-dimethyldecane, and 2,2,3-trimethylnonane, and more preferably 2,2-dimethyldecane.

The specific branched aliphatic hydrocarbon is preferably contained, for example, in the alkylsilane-treated silica particles.

Using the specific branched aliphatic hydrocarbon contained in the alkylsilane-treated silica particles further suppresses the adhesion of the toner in a non-image portion, in a case where the toner is used to continuously form images in a low-temperature and low-humidity environment, then stored in a high-temperature and high-humidity environment, and reused to form images.

Presumably, in a case where the specific branched aliphatic hydrocarbon is contained in the alkylsilane-treated silica particles, the alkyl group derived from the alkylsilane and the specific branched aliphatic hydrocarbon are more likely to come close to each other and may be more easily entangled with each other, which may further suppress the adhesion of the toner on a non-image portion.

Examples of the method of incorporating the specific branched aliphatic hydrocarbon into the alkylsilane-treated silica particles include a method of dissolving the alkylsilane in supercritical carbon dioxide in an alkylsilane treatment performed on the silica base particles by using supercritical carbon dioxide and then dissolving the specific branched aliphatic hydrocarbon in the supercritical carbon dioxide after a passage of certain period time.

Surface Treatment Amount of Alkylsilane and Content of Specific Branched Aliphatic Hydrocarbon

Content of Specific Branched Aliphatic Hydrocarbon

The content of the specific branched aliphatic hydrocarbon with respect to the total amount of the alkylsilane-treated silica particles is, for example, preferably 10 ppm or more and 1,000 ppm or less, more preferably 60 ppm or more and 600 ppm or less, and even more preferably 80 ppm or more and 200 ppm or less.

Presumably, in a case where the content of the specific branched aliphatic hydrocarbon with respect to the total amount of the alkylsilane-treated silica particles is 10 ppm or more, the amount of the specific branched aliphatic hydrocarbon incorporated may be enough for the alkyl group derived from the alkylsilane and the specific branched aliphatic hydrocarbon to be sufficiently entangled with each other.

Presumably, in a case where the content of the specific branched aliphatic hydrocarbon with respect to the total amount of the alkylsilane-treated silica particles is 1,000 ppm or less, the phenomenon may be prevented where the steric hindrance thereof makes it difficult for the side chain of the specific branched aliphatic hydrocarbon and the alkyl group derived from the alkylsilane to be entangled with each other, and the amount of the specific branched aliphatic hydrocarbon incorporated may be enough for preventing the specific branched aliphatic hydrocarbon from being easily isolated from the alkylsilane-treated silica particles, which may make it easy for the specific branched aliphatic hydrocarbon to be present in the non-hydrophobic portion of the alkylsilane-treated silica particles.

Therefore, setting the content of the specific branched aliphatic hydrocarbon to be within the above numerical range further suppresses the adhesion of the toner in a non-image portion, in a case where the toner is used to continuously form images in a low-temperature and low-humidity environment, then stored in a high-temperature and high-humidity environment, and reused to form images.

The content of the specific branched aliphatic hydrocarbon with respect to the alkylsilane-treated silica particles is calculated by the following procedure. Specifically, “content of the specific branched aliphatic hydrocarbon per 10 g of the toner” and “content of the alkylsilane-treated silica particles per 10 g of the toner” are calculated, and from the calculated contents, “content of the specific branched aliphatic hydrocarbon with respect to the alkylsilane-treated silica particles” is calculated.

Calculation of Content of Specific Branched Aliphatic Hydrocarbon per 10 g of Toner

As a measurement target, 10 g of the toner is added to 100 ml of a 0.5% aqueous solution of a surfactant (for example, preferably sodium alkylbenzene sulfonate), thereby obtaining a toner dispersion. The dispersion is subjected to a dispersion treatment for 5 minutes by using an ultrasonic disperser, and filtered using a filter having an opening size of 0.5 μm to separate toner particles. The filtrate is dried, the mass of the dried filtrate is measured, the dried filtrate weighing 200 mg is collected, and the content of the specific branched aliphatic hydrocarbon is analyzed with a headspace gas chromatography mass spectrometer (GCMS-QP2020, Shimadzu Corporation.). The dried filtrate weighing 200 mg is put in a vial, and heated to 190° C. for a heating time of 3 minutes. Then, the volatile components in the vial are introduced into a column (RTX-1, film thickness 1 μm, inner diameter 0.32 mm, length 60 m) and measured under the following column separation conditions. The peak detection amount for a retention time of 16 minutes is converted into n-hexane and adopted as the content of the specific branched aliphatic hydrocarbon per 200 mg of the dried filtrate.

Column separation conditions: holding for 5 minutes at an initial temperature of 40° C., heating to 250° C. at a rate of 5° C./min, and holding for 11 minutes at 250° C. Pressure 120 Pa, purge flow rate 30 ml/min. Ion source temperature 260° C., interface temperature 260° C.

The content of the specific branched aliphatic hydrocarbon per 200 mg of the dried filtrate calculated by the above procedure is converted into a content per total amount of the dried filtrate, and the obtained value is adopted as the content of the specific branched aliphatic hydrocarbon per 10 g of the toner.

Content of Alkylsilane-Treated Silica Particles per 10 g of Toner

Subsequently, the content of the alkylsilane-treated silica particles per 10 g of the toner is calculated.

The content of the alkylsilane-treated silica particles in the toner is analyzed by the measurement method using fluorescent X-rays described below.

First, as a measurement target, 150 mg of the toner is precisely weighed and subjected to pressure molding for 1 minute in a pressure molding machine at 5 t/cm², thereby preparing a disk-shaped measurement sample having a diameter of 10 mm.

Then, for the prepared measurement sample, by using a wavelength dispersive X-ray fluorescence analyzer XRF-1500 (manufactured by Shimadzu Corporation.) and an Rh target, the value of Net intensity (kcps) which is the dose of generated X-rays derived from each element is measured under the measurement conditions of a tube voltage of 40 KV, a tube current of 70 mA, and a measurement time of 30 minutes.

Meanwhile, toners of 7 levels are prepared in advance which consist of toners of 6 levels obtained by varying the amount of silica particles added (amount of silica particles added: 0.5% by mass, 1% by mass, 2% by mass, 5% by mass, 10% by mass, and 20% by mass (all are amounts of silica particles added with respect to the toner particles)) and a toner without silica particles added, and a calibration curve showing the correlation between the amount of silica particles added and the value of Net intensity of fluorescent X-rays is plotted. Then, based on approximation, the content of the alkylsilane-treated silica particles per 10 g of the toner is calculated from the value of Net intensity (kcps) of the measurement sample.

Calculation of Content of Specific Branched Aliphatic Hydrocarbon with Respect to Alkylsilane-Treated Silica Particles

By using “content of the specific branched aliphatic hydrocarbon per 10 g of the toner” and “content of the alkylsilane-treated silica particles per 10 g of the toner” calculated by the above procedure, the content of the specific branched aliphatic hydrocarbon with respect to the alkylsilane-treated silica particles is calculated by the following equation and expressed in ppm.

Equation: Content of specific branched aliphatic hydrocarbon with respect to alkylsilane-treated silica particles=(content of specific branched aliphatic hydrocarbon per 10 g of toner/content of alkylsilane-treated silica particles per 10 g of toner)

Ratio (Content of Branched Aliphatic Hydrocarbon/Surface Treatment Amount of Alkylsilane)

The ratio of the content of the branched aliphatic hydrocarbon to the surface treatment amount of the alkylsilane (content of branched aliphatic hydrocarbon/surface treatment amount of alkylsilane) is, for example, preferably 0.0001 or more and 0.01 or less, more preferably 0.0003 or more and 0.01 or less, and even more preferably 0.0003 or more and 0.006 or less.

Presumably, in a case where the ratio (content of branched aliphatic hydrocarbon/surface treatment amount of alkylsilane) is 0.0001 or more, the amount of the specific branched aliphatic hydrocarbon incorporated may be enough for the alkyl group derived from the alkylsilane and the specific branched aliphatic hydrocarbon to be sufficiently entangled with each other.

In a case where the ratio (content of branched aliphatic hydrocarbon/surface treatment amount of alkylsilane) is 0.01 or less, the amount of the specific branched aliphatic hydrocarbon with respect to the alkyl group derived from alkylsilane is appropriate. Presumably, as a result, the steric hindrance between the specific branched aliphatic hydrocarbons may be suppressed, and the main chain of the specific branched aliphatic hydrocarbon is likely to be present in the non-hydrophobic portion within the surface of the alkylsilane-treated silica particles.

Therefore, setting the content of the specific branched aliphatic hydrocarbon to be within the above numerical range further suppresses the adhesion of the toner in a non-image portion, in a case where the toner is used to continuously form images in a low-temperature and low-humidity environment, then stored in a high-temperature and high-humidity environment, and reused to form images.

The ratio (content of branched aliphatic hydrocarbon/surface treatment amount of alkylsilane) is calculated by dividing “content of the specific branched aliphatic hydrocarbon with respect to the alkylsilane-treated silica particles” calculated by the aforementioned procedure by “surface treatment amount of the alkylsilane” calculated by the following procedure. Both of “content of the specific branched aliphatic hydrocarbon with respect to the alkylsilane-treated silica particles” and “surface treatment amount of the alkylsilane” are expressed in the unit of “% by mass”.

The surface treatment amount of the alkylsilane can be expressed using the amount of alkylsilane used. Furthermore, the surface treatment amount can also be measured as follows.

In a case where the alkylsilane used for the surface treatment of the alkylsilane-treated silica particles as a measurement target has not been identified, pyrolysis GC-MS (GCMS-QP2020 from Shimadzu Corporation./PY2020D from Frontier Laboratories Ltd.) can be used to identify the alkylsilane used for the surface treatment. The measurement is performed using an UltraALLOY-5 (inner diameter 0.25 mm, film thickness 0.25 pm, length 30 m) column under the conditions of an oven temperature of 50° C. and a vaporizing chamber temperature of 310° C., and separation is performed under the conditions of heating to 310° C. at a heating rate of 10° C./min and holding time of 30 minutes. Under the conditions of an ion source temperature of 200° C. and an interface temperature of 310° C., an MS spectrum is obtained after 1.5 minutes of elution to identify the alkylsilane.

As standard samples, surface-treated silica particles having different surface treatment amounts of alkylsilane are prepared. The standard sample is prepared by the following procedure.

Preparation of Standard Sample

By a sol-gel method adopting the same particle size as the alkylsilane-treated silica particles that are a measurement target, silica particles are manufactured. An apparatus equipped with an autoclave with a stirrer (volume: 500 ml) and a back pressure valve is prepared, and the silica particles are put in the autoclave. Then, the autoclave is filled with liquefied carbon dioxide. Thereafter, the stirrer is operated, the autoclave is heated to 170° C. by a heater, and then the pressure is raised to 20 MPa by a carbon dioxide pump. Subsequently, at a point in time when the circulation amount of the supercritical carbon dioxide that has been circulated (integrated value: measured as the circulation amount of carbon dioxide in the standard state) reaches 20 L, the circulation of the supercritical carbon dioxide is stopped, and then the same alkylsilane as the alkylsilane used for the surface treatment of the alkylsilane-treated silica particles that are a measurement target is added.

Then, the temperature is kept at 170° C. by the heater and the pressure is kept at 20 MPa by the carbon dioxide pump such that the supercritical state of the carbon dioxide in the autoclave is maintained. In this state, the stirrer is operated, and the particles are kept for 30 minutes. After the particles are kept for 30 minutes, supercritical carbon dioxide is circulated again, the back pressure valve is opened such that the pressure is reduced to the atmospheric pressure, and the particles are cooled to room temperature. Thereafter, standard samples are taken out of the autoclave.

By the above procedure, surface-treated silica particles having different surface treatment amounts of alkylsilane are prepared as standard samples. Specifically, as standard samples, surface-treated silica particles are prepared which have surface treatment amounts of alkylsilane of 0% by mass, 5% by mass, 10% by mass, 20% by mass, 30% by mass, 40% by mass, and 50% by mass (all of the surface treatment amounts of alkylsilane are mass of the alkylsilane used for the surface treatment with respect to the total mass of the surface-treated silica particles).

By using TG-DTA (DTG-60 manufactured by Shimadzu Corporation.), the alkylsilane treatment amount of the standard samples is measured, and a calibration curve is plotted. TG-DTA is performed under the following conditions. The temperature is raised to 600° C. under the condition of a heating rate of 10° C./min, and the temperature is held at 600° C. for 10 minutes. A difference between the absolute value of a mass loss occurring in a case where the sample is heated to 600° C. and the absolute value of a mass loss occurring in a case where the sample is heated to 180° C. (that is, “absolute value of mass loss occurring in a case where sample is heated to 600° C.—absolute value of mass loss occurring in a case where sample is heated to 180° C.”) is adopted as the alkylsilane treatment amount, and a calibration curve is plotted. This calibration curve is represented by a graph where the ordinate shows the alkylsilane treatment amount (that is, “absolute value of mass loss occurring in a case where sample is heated to 600° C.—absolute value of mass loss occurring in a case where sample is heated to 180° C.”) and the abscissa shows the surface treatment amount of the alkylsilane of the standard sample.

As a measurement target, 10 g of the toner is added to 100 ml of a 0.5% aqueous solution of a surfactant (for example, preferably sodium alkylbenzene sulfonate), thereby obtaining a toner dispersion. The dispersion is subjected to a dispersion treatment for 5 minutes by using an ultrasonic disperser, and filtered using a filter having an opening size of 0.5 μm to separate toner particles. The filtrate is dried to collect the alkylsilane-treated silica particles. The collected alkylsilane-treated silica particles (1 g) are washed with 100 ml of methanol and thoroughly dried. Under the same conditions as the conditions for measuring the standard sample, the alkylsilane treatment amount (that is, “absolute value of mass loss occurring in a case where sample is heated to 600° C.—absolute value of mass loss occurring in a case where sample is heated to 180° C.”) is measured, and from the calibration curve, the surface treatment amount of the alkylsilane (that is, the mass of the alkylsilane used for the surface treatment with respect to the total mass of the alkylsilane-treated silica particles, which is expressed in the unit of % by mass) is calculated.

Toner Particles

The toner particles are composed, for example, of a binder resin and, as necessary, a colorant, a release agent, and other additives.

Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is preferable.

Examples of the polyester resin include known polyester resins.

Examples of the polyester resin include a polycondensate of a polyvalent carboxylic acid and a polyhydric alcohol. As the polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these, lower alkyl esters (for example, having 1 or more and 5 or less carbon atoms) of these, and the like.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among these, for example, aromatic diols and alicyclic diols are preferable as the polyhydric alcohol, and aromatic diols are more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the polyester resin is, for example, preferably 5,000 or more and 1,000,000 or less, and more preferably 7,000 or more and 500,000 or less.

The number-average molecular weight (Mn) of the polyester resin is, for example, preferably 2,000 or more and 100,000 or less.

The molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC.HCL-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is being distilled off. In a case where a monomer with poor compatibility takes part in the reaction, for example, the monomer with poor compatibility may be condensed in advance with an acid or an alcohol that is to be polycondensed with the monomer, and then polycondensed with the main component.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

Colorant

Examples of colorants include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total mass of the toner particles is, for example, preferably 1% by mass or more and 30% by mass or less, and more preferably 3% by mass or more and 15% by mass or less.

Release Agent

Examples of the release agent include hydrocarbon-based wax; natural wax such as carnauba wax, rice wax, and candelilla wax; synthetic or mineral.petroleum-based wax such as montan wax; ester-based wax such as fatty acid esters and montanic acid esters; and the like. The release agent is not limited to these.

In a case where the release agent contains a hydrocarbon compound, the number of carbon atoms of the hydrocarbon compound contained in the release agent is, for example, preferably 19 or more, and more preferably 22 or more.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

Other Additives

Examples of other additives include well-known additives such as a magnetic material, a charge control agent, and inorganic powder. These additives are incorporated into the toner particles as internal additives.

Characteristics of Toner Particles and the Like

The toner particles may be toner particles that have a single-layer structure or toner particles having a so-called core/shell structure that is configured with a core portion (core particle) and a coating layer (shell layer) covering the core portion.

The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter Inc.) and using ISOTON-II (manufactured by Beckman Coulter Inc.) as an electrolytic solution.

For measurement, a measurement sample in an amount of 0.5 mg or more and 50 mg or less is added to 2 ml of a 5% aqueous solution of a surfactant (preferably sodium alkylbenzene sulfonate, for example) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (circular equivalent perimeter)/(perimeter) [(perimeter of circle having the same projected area as particle image)/(perimeter of projected particle image)]. Specifically, the average circularity is a value measured by the following method.

First, toner particles as a measurement target are collected by suction, and a flat flow of the particles is formed. Then, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains external additives, the toner (developer) as a measurement target is dispersed in water containing a surfactant, then the dispersion is treated with ultrasonic waves such that the external additives are removed, and the toner particles are collected.

External Additive

The toner according to the present exemplary embodiment may contain inorganic particles other than alkylsilane-treated silica particles as an external additive.

Examples of the inorganic particles include TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like.

The surface of the inorganic particles as an external additive may have undergone, for example, a hydrophobic treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, an aluminum-based coupling agent, and the like. One kind of each of these agents may be used alone, or two or more kinds of these agents may be used in combination.

Usually, the amount of the hydrophobic agent is, for example, 1 part by mass or more and 10 parts by mass or less with respect to 100 parts by mass of the inorganic particles.

Examples of external additives also include resin particles (resin particles such as polystyrene, polymethylmethacrylate (PMMA), and melamine resins), a cleaning activator (for example, a metal salt of a higher fatty acid represented by zinc stearate or fluorine-based polymer particles), and the like.

The amount of the external additives used in combination with the alkylsilane-treated silica particles with respect to the toner particles is, for example, preferably 0% by mass or more and 5% by mass or less, and more preferably 0% by mass or more and 3% by mass or less.

Manufacturing Method of Toner

Next, the manufacturing method of the toner according to the present exemplary embodiment will be described.

The toner according to the present exemplary embodiment is obtained by manufacturing toner particles and then adding the alkylsilane-treated silica particles to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, for example, in a case where the toner particles are manufactured by the aggregation and coalescence method, the toner particles are manufactured through a step of preparing a resin particle dispersion in which resin particles to be a binder resin are dispersed (a resin particle dispersion-preparing step), a step of allowing the resin particles (plus other particles as necessary) to be aggregated in the resin particle dispersion (having been mixed with another particle dispersion as necessary)so as to form aggregated particles (aggregated particle-forming step), and a step of heating an aggregated particle dispersion in which the aggregated particles are dispersed to allow the aggregated particles to undergo coalescence and to form toner particles (coalescence step).

Hereinafter, each of the steps will be specifically described.

In the following section, a method for obtaining toner particles containing a colorant and a release agent will be described. The colorant and the release agent are used as necessary. It goes without saying that other additives different from the colorant and the release agent may also be used.

Resin Particle Dispersion-Preparing Step

First, for example, a colorant particle dispersion in which colorant particles are dispersed and a release agent particle dispersion in which release agent particles are dispersed are prepared together with the resin particle dispersion in which resin particles to be a binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of these media may be used alone, or two or more kinds of these media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, for example, an anionic surfactant and a cationic surfactant are particularly preferable. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase transition) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the resin particle dispersion. That is, the volume-average particle size of particles, the dispersion medium, the dispersion method, and the particle content in the resin particle dispersion are also applied to the colorant particles to be dispersed in the colorant particle dispersion and the release agent particles to be dispersed in the release agent particle dispersion.

Aggregated Particle-Forming Step

Next, the resin particle dispersion is mixed with the colorant particle dispersion and the release agent particle dispersion.

Then, in the mixed dispersion, the resin particles, the colorant particles, and the release agent particles are hetero-aggregated such that aggregated particles are formed which have a diameter close to the diameter of the target toner particles and include the resin particles, the colorant particles, and the release agent particles.

Specifically, for example, an aggregating agent is added to the mixed dispersion, the pH of the mixed dispersion is adjusted such that the dispersion is acidic (for example, pH of 2 or higher and 5 or lower), and a dispersion stabilizer is added thereto as necessary. Then, the dispersion is heated to the glass transition temperature of the resin particles (specifically, for example, to a temperature equal to or higher than the glass transition temperature of the resin particles −30° C. and equal to or lower than the glass transition temperature of the resin particles −10° C.) such that the particles dispersed in the mixed dispersion are aggregated, thereby forming aggregated particles.

In the aggregated particle-forming step, for example, in a state where the mixed dispersion is being stirred with a rotary shearing homogenizer, an aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. Particularly, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; inorganic metal salt polymers such as polyaluminum chloride, polyaluminum hydroxide, and calcium polysulfide; and the like.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA), and the like.

The amount of the chelating agent added with respect to 100 parts by mass of resin particles is, for example, preferably 0.01 parts by mass or more and 5.0 parts by mass or less, and more preferably 0.1 parts by mass or more and less than 3.0 parts by mass.

Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed to cause the resin particles to be aggregated and adhere to the surface of the aggregated particles and to form second aggregated particles, and a step of heating a second aggregated particle dispersion in which the second aggregated particles are dispersed to cause the second aggregated particles to coalesce and to form toner particles having a core/shell structure.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

Then, for example, by adding the alkylsilane-treated silica particles to the obtained dry toner particles and mixing together the alkylsilane-treated silica particles and the toner particles, the toner according to the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer which contains only the toner according to the present exemplary embodiment or a two-component developer which is obtained by mixing together the toner and a carrier.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; a resin impregnation-type carrier obtained by impregnating porous magnetic powder with a resin; and the like.

Each of the magnetic powder dispersion-type carrier and the resin impregnation-type carrier may be a carrier obtained by coating a core material, which is particles configuring the carrier, with a coating resin.

Examples of the magnetic powder include magnetic metals such as iron, nickel, and cobalt; magnetic oxides such as ferrite and magnetite; and the like.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, an epoxy resin, and the like.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, which are used as necessary, in an appropriate solvent, and the like. The solvent is not particularly limited, and may be selected in consideration of the type of the coating resin used, coating suitability, and the like.

Specifically, examples of the resin coating method include an immersion method of immersing the core material in the solution for forming a coating layer; a spray method of spraying the solution for forming a coating layer to the surface of the core material; a fluidized bed method of spraying the solution for forming a coating layer to the core material that is floating by an air flow; a kneader coater method of mixing the core material of the carrier with the solution for forming a coating layer in a kneader coater and removing solvents; and the like.

The mixing ratio (mass ratio) between the toner and the carrier, represented by toner:carrier, in the two-component developer is, for example, preferably 1:100 to 30:100, and more preferably 3:100 to 20:100.

Image Forming Apparatus/Image Forming Method

The image forming apparatus/image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, well-known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralizing unit that neutralizes charge by irradiating the surface of the image holder with charge neutralizing light before charging after the transfer of the toner image.

In the case of the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) to be attached to and detached from the image forming apparatus. As the process cartridge, for example, a process cartridge is suitably used which includes a developing unit that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

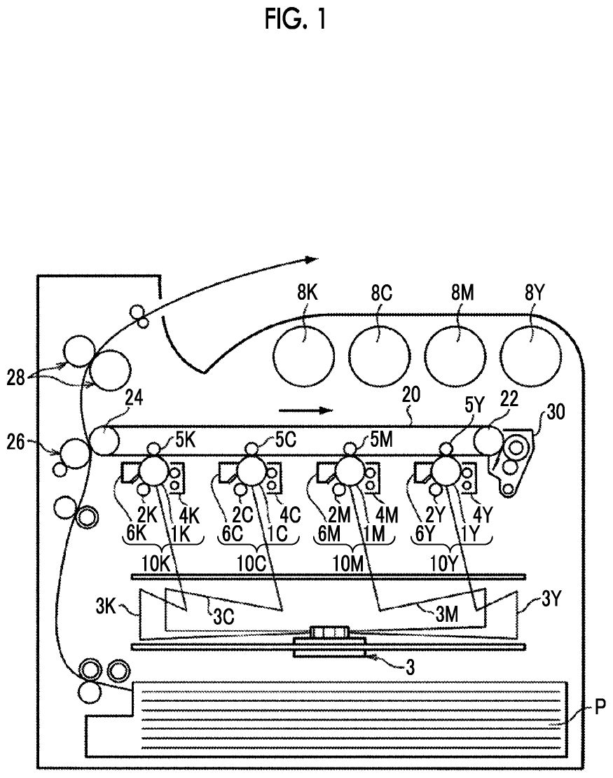

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming means) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 which is in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the surface of the intermediate transfer belt 20 on the side of image holding surface.

Toners including toners of four colors, yellow, magenta, cyan, and black, stored in containers of toner cartridges 8Y, 8M, 8C, and 8K are supplied to developing devices (developing units) 4Y, 4M, 4C, and 4K of units 10Y, 10M, 10C, and 10K, respectively.

The first to fourth units 10Y, 10M, 10C, and 10K have the same configuration. Therefore, in the present specification, as a representative, the first unit 10Y will be described which is placed on the upstream side of the running direction of the intermediate transfer belt and forms a yellow image. Reference numerals marked with magenta (M), cyan (C), and black (K) instead of yellow (Y) are assigned in the same portions as those in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of charging unit) 2Y that charges the surface of the photoreceptor 1Y at a predetermined potential, an exposure device (an example of electrostatic charge image forming unit) 3 that exposes the charged surface to a laser beam 3Y based on color-separated image signals to form an electrostatic charge image, a developing device (an example of developing unit) 4Y that develops the electrostatic charge image by supplying a charged toner to the electrostatic charge image, a primary transfer roll (an example of primary transfer unit) 5Y that transfers the developed toner image onto the intermediate transfer belt 20, and a photoreceptor cleaning device (an example of cleaning unit) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.:1×10⁻⁶ Ωcm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y is rotated to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). Then, as the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

Meanwhile, the residual toner on the photoreceptor 1Y is removed by a photoreceptor cleaning device 6Y and collected.

Furthermore, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll 26 (an example of secondary transfer unit) disposed on the image holding surface side of the intermediate transfer belt 20. Meanwhile, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Then, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet and the like, in addition to the recording paper P.

In order to further improve the smoothness of the image surface after fixing, for example, it is preferable that the surface of the recording paper P be also smooth. For instance, coated paper prepared by coating the surface of plain paper with a resin or the like, art paper for printing, and the like are suitably used.

The recording paper P on which the color image has been fixed is transported to an output portion, and a series of color image forming operations is finished.

Process Cartridge/Toner Cartridge

The process cartridge according to the present exemplary embodiment will be described.

The process cartridge according to the present exemplary embodiment includes a developing unit which contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawing, main parts will be described, and others will not be described.

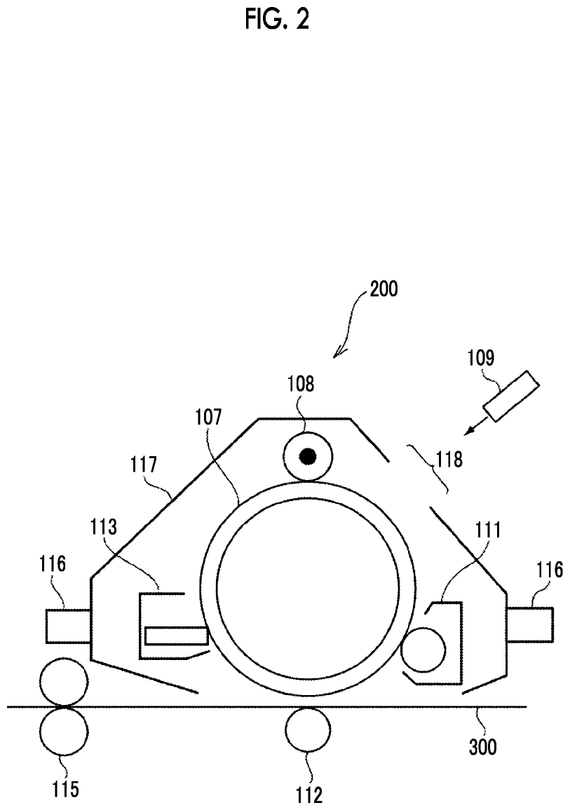

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), which are integrally combined and held in the housing 117. The process cartridge 200 forms a cartridge in this way.

In FIG. 2, 109 represents an exposure device (an example of electrostatic charge image forming unit), 112 represents a transfer device (an example of transfer unit), 115 represents a fixing device (an example of fixing unit), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In a case where the amount of the toner contained in the container of the toner cartridge is low, the toner cartridge is replaced.

### EXAMPLES

Examples will be described below, but the present invention is not limited to these examples. In the following description, unless otherwise specified, “parts” and “%” are based on mass in all cases.

Preparation of Toner Particles

Preparation of Amorphous Polyester Resin Dispersion (A1)

Ethylene glycol: 37 parts

Neopentyl glycol: 65 parts

1,9-Nonanediol: 32 parts

Terephthalic acid: 96 parts

The above materials are put in a reactor, the temperature is raised to 200° C. for 1 hour, and after it is confirmed that the inside of the reaction system is uniformly stirred, 1.2 parts of dibutyltin oxide is added. The temperature is raised to 240° C. for 6 hours in a state where the generated water is being distilled off, and stirring is continued at 240° C. for 4 hours, thereby obtaining an amorphous polyester resin (acid value 9.4 mgKOH/g, weight-average molecular weight 13,000, glass transition temperature 62° C.). Molten amorphous polyester resin is transferred as it is to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the amorphous polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining an amorphous polyester resin dispersion (A1) having a volume-average particle size of 160 nm and a solid content of 20%.

Preparation of Crystalline Polyester Resin Dispersion (C1)

Decanedioic acid: 81 parts

Hexanediol: 47 parts

The above materials are put in a reactor, the temperature is raised to 160° C. for 1 hour, and after it is confirmed that the inside of the reaction system is uniformly stirred, 0.03 parts of dibutyltin oxide is added. While the generated water is being distilled off, the temperature is raised to 200° C. for 6 hours, and stirring is continued for 4 hours at 200° C. Thereafter, the reaction solution is cooled, solid-liquid separation is performed, and the solid is dried at a temperature of 40° C. under reduced pressure, thereby obtaining a crystalline polyester resin (C1) (melting point 64° C., weight-average molecular weight of 15,000).

Crystalline polyester resin (C1): 50 parts

Anionic surfactant (manufactured by DKS Co. Ltd., NEOGEN RK): 2 parts

Deionized water: 200 parts

The above materials are heated to 120° C., thoroughly dispersed with a homogenizer (ULTRA-TURRAX T50, manufactured by IKA), and then subjected to a dispersion treatment with a pressure jet-type homogenizer. At a point in time when the volume-average particle size reaches 180 nm, the dispersed resultant is collected, thereby obtaining a crystalline polyester resin dispersion (C1) having a solid content of 20%.

Preparation of Release Agent Particle Dispersion (W1)

Paraffin wax (manufactured by NIPPON SEIRO CO., LTD., HNP-9,): 100 parts

Anionic surfactant (manufactured by DKS Co. Ltd., NEOGEN RK): 1 part

The above materials are mixed together, heated to 100° C., and dispersed using a homogenizer (ULTRA-TURRAX T50 manufactured by IKA). Then, by using a pressure jet-type Gorlin homogenizer, a dispersion treatment is performed, thereby obtaining a release agent particle dispersion in which release agent particles having a volume-average particle size of 200 nm are dispersed. Deionized water is added to the release agent particle dispersion such that the solid content thereof is adjusted to 20%, thereby obtaining a release agent particle dispersion (W1).

Preparation of Colorant Particle Dispersion (C1)

Cyan pigment (Pigment Blue 15:3, Dainichiseika Color & Chemicals Mfg. Co., Ltd.): 50 parts

Anionic surfactant (manufactured by DKS Co. Ltd., NEOGEN RK): 5 parts

Deionized water: 195 parts

The above materials are mixed together and subjected to a dispersion treatment for 60 minutes by using a high-pressure impact disperser (ULTIMIZER HJP30006, manufactured by SUGINO MACHINE LIMITED), thereby obtaining a colorant particle dispersion (C1) having a solid content of 20%.

Preparation of Toner Particles

Deionized water: 200 parts

Amorphous polyester resin dispersion (A1): 150 parts

Crystalline polyester resin dispersion (C1): 10 parts

Release agent particle dispersion (W1): 10 parts

Colorant particle dispersion (C1): 15 parts

Anionic surfactant (TaycaPower): 2.8 parts

The above materials are put in a reactor, 0.1N nitric acid is added thereto to adjust the pH to 3.5, and then an aqueous polyaluminum chloride solution obtained by dissolving 2 parts of polyaluminum chloride (manufactured by Oji Paper Co., Ltd., 30% powder product) in 30 parts of deionized water is added thereto. The obtained solution is dispersed at 30° C. by using a homogenizer (ULTRA-TURRAX T50 manufactured by IKA), then heated to 45° C. in an oil bath for heating, and kept as it is until the volume-average particle size reaches 4.9 Next, 60 parts of the amorphous polyester resin dispersion (Al) is added thereto, and the mixture is kept as it is for 30 minutes. Thereafter, at a point in time when the volume-average particle size reaches 5.2 μm, 60 parts of the amorphous polyester resin dispersion (A1) is further added thereto, and the mixture is kept as it is for 30 minutes. Subsequently, 20 parts of a 10% aqueous solution of NTA (nitrilotriacetic acid) metal salt (CHELEST 70, manufactured by CHELEST CORPORATION) is added thereto, and a 1N aqueous sodium hydroxide solution is added thereto to adjust the pH to 9.0. Then, 1 part of an anionic surfactant (TaycaPower) is added thereto, and the mixture is heated to 85° C. while being continuously stirred and kept as it is for 5 hours. The mixture is then cooled to 20° C. at a rate of 20° C./min. Thereafter, the mixture is filtered, thoroughly washed with deionized water, and dried, thereby obtaining toner particles having a volume-average particle size of 5.7 μm and an average circularity of 0.971.

Preparation of Alkylsilane-Treated Silica Particles

Alkylsilane-Treated Silica Particles (S1)

Preparation of Silica Base Particles

Methanol (255 parts) and 54 parts of 10% aqueous ammonia are added to a 1.5 L glass reactor equipped with a stirrer, a dripping nozzle, and a thermometer, followed by mixing, thereby obtaining a mixed solution. The temperature of the mixed solution is adjusted to 25° C., and then 180 parts of tetramethoxysilane and 79 parts of 3.8% aqueous ammonia are added dropwise thereto at the same addition start point for 60 minutes under stirring, thereby obtaining 568 parts of a hydrophilic silica particle dispersion.

Then, 568 parts of methanol is added to the hydrophilic silica particle dispersion, and the mixture is heated at 60° C. under stirring until the dispersion is concentrated to a mass of 420 parts. The operation is repeated twice more, thereby obtaining a concentrated dispersion. The weight ratio of silica in the concentrated dispersion is adjusted to 50%, and the weight ratio of water to alcohol in the concentrated dispersion is adjusted to 0, thereby obtaining a silica base particle dispersion.

Alkylsilane Treatment

The silica base particle dispersion is subjected to a solvent removal treatment and an alkylsilane treatment as shown below.

An apparatus equipped with an autoclave with a stirrer (volume: 500 ml) and a back pressure valve is prepared, and 400 parts of the silica base particle dispersion is added to the autoclave. Then, the autoclave is filled with liquefied carbon dioxide. Thereafter, the stirrer is operated at 200 rpm, the autoclave is heated to 150° C. by a heater, and then the pressure is raised to 20 MPa by a carbon dioxide pump. In this way, supercritical carbon dioxide is circulated in the autoclave such that the solvent of the silica base particle dispersion is removed. A trapping device is kept at 0° C. by a refrigerant such that the removed solvent can be separated from carbon dioxide. The flow rate of carbon dioxide is measured with a gas flow meter.

Subsequently, at a point in time when the circulation amount of the supercritical carbon dioxide that has been circulated (integrated value: measured as the circulation amount of carbon dioxide in the standard state) reaches 20 L, the circulation of the supercritical carbon dioxide is stopped, and then trimethylmethoxysilane as an alkylsilane is added thereto such that the alkylsilane-treated silica particles have a surface treatment amount of the alkylsilane of 25% by mass. Next, as the specific branched aliphatic hydrocarbon, 2,2-dimethyldecane is added thereto such that the content of the specific branched aliphatic hydrocarbon is 120 ppm with respect to the total mass of the alkylsilane-treated silica particles.

Then, the temperature is kept at 150° C. by the heater and the pressure is kept at 20 MPa by the carbon dioxide pump such that the supercritical state of the carbon dioxide in the autoclave is maintained. In this state, the stirrer is operated at 200 rpm, and the particles are kept for 30 minutes as a hydrophobic treatment time. After the particles are kept for 30 minutes, supercritical carbon dioxide is circulated again, the back pressure valve is opened such that the pressure is reduced to the atmospheric pressure, and the particles are cooled to room temperature. Thereafter, alkylsilane-treated silica particles (S1) are taken out of the autoclave. The particle size of the obtained alkylsilane-treated silica particles (S1) is 85 nm.

Alkylsilane-Treated Silica Particles (S2) to (S21)

Alkylsilane-treated silica particles are obtained by the same procedure as the preparation procedure of the alkylsilane-treated silica particles (S1), except that the type of alkylsilane and the type of branched aliphatic hydrocarbon are changed as shown in Table 1, the amount of the alkylsilane added is changed such that the surface treatment amount of the alkylsilane of the alkylsilane-treated silica particles is as shown in Table 1, and the amount of the branched aliphatic hydrocarbon added is changed such that the content of the branched aliphatic hydrocarbon with respect to the total mass of the alkylsilane-treated silica particles is as shown in Table 1.

Alkylsilane-Treated Silica Particles (S22)

Alkylsilane-treated silica particles are obtained by the same procedure as the preparation procedure of the alkylsilane-treated silica particles (S1), except that in Preparation of Silica Base Particles, the amount of 10% aqueous ammonia added is changed to 43 parts by mass, and the amount of tetramethoxysilane is changed to 160 parts by mass. The particle size of the obtained silica particles (S22) is 65 nm.

TABLE 1

| | | | Branched aliphatic hydrocarbon | | |
|---|---|---|---|---|---|
| | | | | Content of specific | |
| | Alkylsilane | | | branched aliphatic | |
| | | Surface | | hydrocarbon with | |
| Type of | | treatment | | respect to total amount | |
| alkylsilane-treated | | amount of | | of alkylsilane-treated | |
| silica particles | Type | alkylsilane | Type | silica particles | |
| S1 | Trimethylmethoxysilane | 25% | 2,2-Dimethyldecane | 120 | ppm |
| S2 | Methyltrimethoxysilane | 25% | 2,2-Dimethyldecane | 120 | ppm |
| S3 | Trimethylmethoxysilane | 25% | — | 0 | ppm |
| S4 | Trimethylmethoxysilane | 25% | 2,2-Dimethylpentane | 120 | ppm |
| S5 | Trimethylmethoxysilane | 25% | 2,2-Dimethylbutane | 120 | ppm |
| S6 | Trimethylmethoxysilane | 25% | 2,2-Dimethylhexadecane | 120 | ppm |
| S7 | Trimethylmethoxysilane | 25% | 2,2-Dimethylheptadecane | 120 | ppm |
| S8 | Hexyltrimethoxysilane | 25% | 2,2-Dimethyldecane | 120 | ppm |
| S9 | Triethylmethoxysilane | 25% | 2,2-Dimethyldecane | 120 | ppm |
| S10 | Trimethylmethoxysilane | 25% | 3,6-Dimethyldecane | 120 | ppm |
| S11 | Trimethylmethoxysilane | 25% | 2,2,3-Trimethyldecane | 120 | ppm |
| S12 | Trimethylmethoxysilane | 25% | 3,3,8,8-Tetramethyldecane | 120 | ppm |
| S13 | Trimethylmethoxysilane | 5% | 2,2-Dimethyldecane | 100 | ppm |
| S14 | Trimethylmethoxysilane | 5% | 2,2-Dimethyldecane | 80 | ppm |
| S15 | Trimethylmethoxysilane | 40% | 2,2-Dimethyldecane | 1000 | ppm |
| S16 | Trimethylmethoxysilane | 40% | 2,2-Dimethyldecane | 1100 | ppm |
| S17 | Trimethylmethoxysilane | 50% | 2,2-Dimethyldecane | 50 | ppm |
| S18 | Trimethylmethoxysilane | 50% | 2,2-Dimethyldecane | 25 | ppm |
| S19 | Trimethylmethoxysilane | 10% | 2,2-Dimethyldecane | 1000 | ppm |
| S20 | Trimethylmethoxysilane | 8.5% | 2,2-Dimethyldecane | 1000 | ppm |
| S21 | Trimethylmethoxysilane | 25% | 3,3,5-Trimethyldecane | 120 | ppm |
| S22 | Trimethylmethoxysilane | 25% | 2,2-Dimethyldecane | 120 | ppm |

In Table 1, “-” means that the branched aliphatic hydrocarbon is not added.

### Example 1: Preparation of Toner and Developer

The alkylsilane-treated silica particles (Si) (2 parts) are added to 100 parts of the toner particles, followed by mixing using a Henschel mixer at a circumferential speed of stirring of 30 m/sec for 15 minutes, thereby obtaining toners.

Then, each of the obtained toners and the following resin-coated carrier is put in a V blender at a ratio of toner: carrier =8:92 (mass ratio) and stirred for 20 minutes, thereby obtaining a developer.

Carrier

Mn—Mg—Sr-based ferrite particles (average particle size: 40 μm): 100 parts

Toluene: 14 parts

Polymethyl methacrylate: 2 parts

Carbon black (VXC72: manufactured by Cabot Corporation): 0.12 parts

The above materials excluding ferrite particles are mixed with glass beads (diameter: 1 mm, in the same amount as toluene), and the mixture is stirred with a sand mill manufactured by Kansai Paint Co., Ltd. at a rotation speed of 1,200 rpm for 30 minutes, thereby obtaining a dispersion. The dispersion and the ferrite particles are put in a vacuum deaeration-type kneader and dried under reduced pressure with stirring, thereby obtaining a resin-coated carrier.

### Examples 2 to 19 and Comparative Examples 1 to 3

Toners and developers are obtained by the same procedure as in Example 1, except that the type of alkylsilane-treated silica particles added to the toner particles is changed as shown in Table 2.

Evaluation

The developer obtained in each example is put in an image forming apparatus DCC400 (manufactured by FUJIFILM Business Innovation Corp.) in which a density sensor is canceled, and in an environment at 10° C. and 15% RH, an A3 halftone (solid image having an image density of 5%) image is printed on 2,000 sheets of A3 size paper (manufactured by FUJIFILM Business Innovation Corp., J paper). Then, the image forming apparatus is left to stand for 5 days in an environment at 28° C. and 88% RH. After being left to stand, the image forming apparatus is used to print the A3 solid image on 10 sheets and then to print a blank image (image density: 0%) on 10 sheets. The 10 sheets with a printed blank image are checked and evaluated based on the following evaluation criteria.

Evaluation Criteria

G1: In all the 10 sheets with a blank image, contamination with a toner is not observed with a loupe.

G2: Although contamination with a toner is observed with a loupe, the number of sheets with a blank image where contamination is observed is 2 or less, which is in an acceptable range for practical use.

G2.5: Although contamination with a toner is observed with a loupe, the number of sheets with a blank image where contamination is observed is 3, which is in an acceptable range for practical use.

G3: Although contamination with a toner is observed with a loupe, the number of sheets with a blank image where contamination is observed is 4, which is in an acceptable range for practical use.

G4: Contamination with a toner is visually observed, and the number of sheets with a blank image where contamination is observed is 5, which is outside the acceptable range for practical use.

G5: Contamination with a toner is visually observed, and the number of sheets with a blank image where contamination is observed is 6 or more, which is outside the acceptable range for practical use.

TABLE 2

| | Type of | | Branched aliphatic hydrocarbon | | | | | | |
|---|---|---|---|---|---|---|---|---|---|
| | alkyl- | | | | Presence | Content | Location where | Ratio | |
| | silane- | | | Number | or | with respect | branched | (amount | |
| | treated | | | of | absence of | to silica | aliphatic | of HC/ | |
| | silica | Alkylsilane | | carbon | quaternary | particles | hydrocarbon | amount | Evalu- |
| | particles | Type | Type | atoms | carbon | (ppm) | is contained | of AlSi) | ation |
| Example 1 | S1 | Trimethylmethoxysilane | 2,2-Dimethyldecane | 12 | Present | 120 | Silica particles | 0.0004 | G1 |
| Example 2 | S2 | Methyltrimethoxysilane | 2,2-Dimethyldecane | 12 | Present | 120 | Silica particles | 0.0004 | G1 |
| Comparative | S3 | Trimethylmethoxysilane | — | — | — | 0 | — | 0 | G5 |
| Example 1 | | | | | | | | | |
| Example 3 | S4 | Trimethylmethoxysilane | 2,2-Dimethylpentane | 7 | Present | 120 | Silica particles | 0.0004 | G3 |
| Comparative | S5 | Trimethylmethoxysilane | 2,2-Dimethylbutane | 6 | Present | 120 | Silica particles | 0.0004 | G4 |
| Example 2 | | | | | | | | | |
| Example 4 | S6 | Trimethylmethoxysilane | 2,2-Dimethylhexadecane | 18 | Present | 120 | Silica particles | 0.0004 | G3 |
| Comparative | S7 | Trimethylmethoxysilane | 2,2-Dimethylheptadecane | 19 | Present | 120 | Silica particles | 0.0004 | G4 |
| Example 3 | | | | | | | | | |
| Example 5 | S8 | Hexyltrimethoxysilane | 2,2-Dimethyldecane | 12 | Present | 120 | Silica particles | 0.0004 | G2.5 |
| Example 6 | S9 | Trimethylmethoxysilane | 2,2-Dimethyldecane | 12 | Present | 120 | Silica particles | 0.0004 | G2 |
| Example 7 | S10 | Trimethylmethoxysilane | 3,6-Dimethyldecane | 12 | Absent | 120 | Silica particles | 0.0004 | G2 |
| Example 8 | S21 | Trimethylmethoxysilane | 3,3,5-Trimethyldecane | 13 | Present | 120 | Silica particles | 0.0004 | G1 |
| Example 9 | S11 | Trimethylmethoxysilane | 2,2,3-Trimethyldecane | 13 | Present | 120 | Silica particles | 0.0004 | G1 |
| Example 10 | S12 | Trimethylmethoxysilane | 3,3,8,8- | 14 | Present | 120 | Silica particles | 0.0004 | G2 |
| | | | Tetramethyldecane | | | | | | |
| Example 11 | S13 | Trimethylmethoxysilane | 2,2-Dimethyldecane | 12 | Present | 10 | Silica particles | 0.0002 | G2.5 |
| Example 12 | S14 | Trimethylmethoxysilane | 2,2-Dimethyldecane | 12 | Present | 8 | Silica particles | 0.0002 | G3 |
| Example 13 | S15 | Trimethylmethoxysilane | 2,2-Dimethyldecane | 12 | Present | 1000 | Silica particles | 0.0025 | G2 |
| Example 14 | S16 | Trimethylmethoxysilane | 2,2-Dimethyldecane | 12 | Present | 1100 | Silica particles | 0.0028 | G3 |
| Example 15 | S17 | Trimethylmethoxysilane | 2,2-Dimethyldecane | 12 | Present | 50 | Silica particles | 0.0001 | G2 |
| Example 16 | S18 | Trimethylmethoxysilane | 2,2-Dimethyldecane | 12 | Present | 25 | Silica particles | 0.00005 | G2.5 |
| Example 17 | S19 | Trimethylmethoxysilane | 2,2-Dimethyldecane | 12 | Present | 1000 | Silica particles | 0.01 | G2 |
| Example 18 | S20 | Trimethylmethoxysilane | 2,2-Dimethyldecane | 12 | Present | 1000 | Silica particles | 0.012 | G2.5 |
| Example 19 | S22 | Trimethylmethoxysilane | 2,2-Dimethyldecane | 12 | Present | 120 | Silica particles | 0.0004 | G2 |

The description in Table 2 is as below.

“Content (%) with respect to silica particles” described in the column under Branched aliphatic hydrocarbon: content of branched aliphatic hydrocarbon with respect to total amount of alkylsilane-treated silica particles

Ratio (amount of HC/amount of AlSi): ratio of content of branched aliphatic hydrocarbon to surface treatment amount of the alkylsilane (content of branched aliphatic hydrocarbon/surface treatment amount of alkylsilane)

In Table 2, “-” means that the branched aliphatic hydrocarbon is not contained. The above results tell that the toner of the present example is inhibited from adhering to a non-image portion, in a case where the toner is used to continuously form images in a low-temperature and low-humidity environment, then stored in a high-temperature and high-humidity environment, and reused to form images.

(((1))) An electrostatic charge image developing toner comprising: alkylsilane-treated silica particles;

a branched aliphatic hydrocarbon having 7 or more and 18 or less carbon atoms; and toner particles.

(((2))) The electrostatic charge image developing toner according to (((1))),

wherein the alkylsilane is at least one kind of compound selected from the group consisting of alkylsilanes represented by Formula (1), Formula (2), and Formula (3).

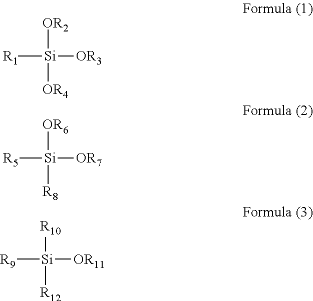

(In Formula (1) to Formula (3), R₁ to R₁₂ each independently represent an alkyl group having 1 or more and 3 or less carbon atoms.)

(((3))) The electrostatic charge image developing toner according to (((2))),

wherein all of alkyl groups of the alkylsilanes are methyl groups.

(((4))) The electrostatic charge image developing toner according to any one of (((1))) to (((3))),

wherein the branched aliphatic hydrocarbon has a quaternary carbon.

(((5))) The electrostatic charge image developing toner according to (((4))),

wherein the quaternary carbon is contained in a group represented by Formula (4).

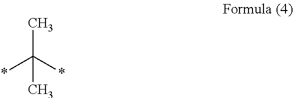 [SMILES: *C(*)(C)C]

(In Formula (4), * represents a bonding site.)

(((6))) The electrostatic charge image developing toner according to any one of (((1))) to (((5))),

wherein the branched aliphatic hydrocarbon has 7 or more and 13 or less carbon atoms.

(((7))) The electrostatic charge image developing toner according to any one of (((1))) to (((6)))

wherein a content of the branched aliphatic hydrocarbon is 10 ppm or more and 1,000 ppm or less with respect to a total amount of the silica particles.

(((8))) The electrostatic charge image developing toner according to any one of (((1))) to (((7))),

wherein a ratio of a content of the branched aliphatic hydrocarbon to a surface treatment amount of the alkylsilane (content of branched aliphatic hydrocarbon/surface treatment amount of alkylsilane) is 0.0001 or more and 0.01 or less.

(((9))) The electrostatic charge image developing toner according to any one of (((1))) to (((8))),

wherein the branched aliphatic hydrocarbon is contained in the silica particles.

(((10))) An electrostatic charge image developer comprising: the electrostatic charge image developing toner according to any one of (((1))) to (((9))).

(((11))) A toner cartridge comprising:

a container that contains the electrostatic charge image developing toner according to any one of (((1))) to (((9))),

wherein the toner cartridge is detachable from an image forming apparatus.

(((12))) A process cartridge comprising:

a developing unit that contains the electrostatic charge image developer according to (((10))) and develops an electrostatic charge image formed on a surface of an image holder as a toner image by using the electrostatic charge image developer,

wherein the process cartridge is detachable from an image forming apparatus.

(((13))) An image forming apparatus comprising:

an image holder;

a charging unit that charges a surface of the image holder;

an electrostatic charge image forming unit that forms an electrostatic charge image on the charged surface of the image holder;

a developing unit that contains the electrostatic charge image developer according (((10))) and develops the electrostatic charge image formed on the surface of the image holder as a toner image by using the electrostatic charge image developer;

a transfer unit that transfers the toner image formed on the surface of the image holder to a surface of a recording medium; and

a fixing unit that fixes the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
alkylsilane-treated silica particles;
a branched aliphatic hydrocarbon having 7 or more and 18 or less carbon atoms; and
toner particles.

2. The electrostatic charge image developing toner according to claim 1,
wherein the alkylsilane is at least one kind of compound selected from the group consisting of alkylsilanes represented by Formula (1), Formula (2), and Formula (3), 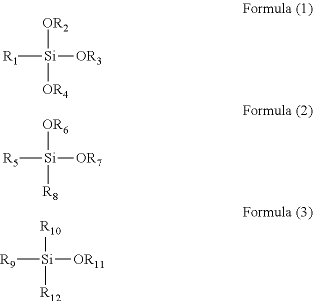
(in Formula (1) to Formula (3), R₁ to R₁₂ each independently represent an alkyl group having 1 or more and 3 or less carbon atoms).

3. The electrostatic charge image developing toner according to claim 2,
wherein all of alkyl groups of the alkylsilanes are methyl groups.

4. The electrostatic charge image developing toner according to claim 1,
wherein the branched aliphatic hydrocarbon has a quaternary carbon.

5. The electrostatic charge image developing toner according to claim 4,
wherein the quaternary carbon is contained in a group represented by Formula (4), 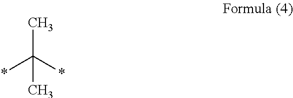 [SMILES: *C(*)(C)C]
(in Formula (4), * represents a bonding site).

6. The electrostatic charge image developing toner according to claim 1,
wherein the branched aliphatic hydrocarbon has 7 or more and 13 or less carbon atoms.

7. The electrostatic charge image developing toner according to claim 1,
wherein a content of the branched aliphatic hydrocarbon is 10 ppm or more and 1,000 ppm or less with respect to a total amount of the silica particles.

8. The electrostatic charge image developing toner according to claim 1,
wherein a ratio of a content of the branched aliphatic hydrocarbon to a surface treatment amount of the alkylsilane (content of branched aliphatic hydrocarbon/surface treatment amount of alkylsilane) is 0.0001 or more and 0.01 or less.

9. The electrostatic charge image developing toner according to claim 1,
wherein the branched aliphatic hydrocarbon is contained in the silica particles.

10. An electrostatic charge image developer comprising:
the electrostatic charge image developing toner according to claim 1.

11. An electrostatic charge image developer comprising:
the electrostatic charge image developing toner according to claim 2.

12. An electrostatic charge image developer comprising:
the electrostatic charge image developing toner according to claim 3.

13. An electrostatic charge image developer comprising:
the electrostatic charge image developing toner according to claim 4.

14. An electrostatic charge image developer comprising:
the electrostatic charge image developing toner according to claim 5.

15. An electrostatic charge image developer comprising:
the electrostatic charge image developing toner according to claim 6.

16. An electrostatic charge image developer comprising:
the electrostatic charge image developing toner according to claim 7.

17. An electrostatic charge image developer comprising:
the electrostatic charge image developing toner according to claim 8.

18. A toner cartridge comprising:
a container that contains the electrostatic charge image developing toner according to claim 1,
wherein the toner cartridge is detachable from an image forming apparatus.

19. A process cartridge comprising:
a developing unit that contains the electrostatic charge image developer according to claim 10 and develops an electrostatic charge image formed on a surface of an image holder as a toner image by using the electrostatic charge image developer,
wherein the process cartridge is detachable from an image forming apparatus.

20. An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to claim 10 and develops the electrostatic charge image formed on the surface of the image holder as a toner image by using the electrostatic charge image developer;
a transfer unit that transfers the toner image formed on the surface of the image holder to a surface of a recording medium; and
a fixing unit that fixes the toner image transferred to the surface of the recording medium.
